(19) United States
(12) Patent Application Publication
(10) Pub. No.: US 2016/0144959 A1
(43) Pub. Date: May 26, 2016

(54) Systems, Methods and Devices for Collecting Data at Remote Oil and Natural Gas Sites

(71) Applicant: Oil & Gas IT, LLC, San Antonio, TX (US)

(72) Inventor: Greg Meffert, San Antonio, TX (US)

(73) Assignee: OIL & GAS IT, LLC, Laredo, TX (US)

(21) Appl. No.: 14/876,921

(22) Filed: Oct. 7, 2015

Related U.S. Application Data
(60) Provisional application No. 62/216,434, filed on Sep. 10, 2015.
(60) Provisional application No. 62/193,712, filed on Jul. 17, 2015.
(60) Provisional application No. 62/082,766, filed on Nov. 21, 2014.

(51) Int. Cl. B64C 39/02; B64D 47/08

(52) U.S. Cl. CPC B64C 39/024; B64D 47/08; B64C 2201/146; B64C 2201/127

(57) ABSTRACT

Systems, methods and devices are provided for collecting operational data at remote oil and natural gas sites, such as wells, and or processing and refinery plants. One such system comprises a remote transmitter and/or controller at the site and an unmanned aerial vehicle (UAV), such as a drone aircraft, configured for aerial dispatch to the remote site and wireless connection to the remote transmitter for subsequent relay or upload of data to an external processor. The UAV may include still or video cameras for collecting images around the well site that can be uploaded and transmitted to the external processor. The system may also include logic-based applications allowing for feedback control of the well site to change operational parameters based on the received data. The system may also include a variety of sophisticated sensor devices on the UAV or located at the remote site to collect additional operational data, such as airborne particulate and/or toxic gas concentrations, audio files of pumps or other equipment and levels and properties of produced water and other fluids.

### CROSS-REFERENCES TO RELATED APPLICATIONS

This original non-provisional application claims priority to and the benefit of U.S. provisional application Ser. No. 62/216,434 (filed Sep. 10, 2015), U.S. provisional application Ser. No. 62/193,712 (filed Jul. 17, 2015), and U.S. provisional application Ser. No. 62/082,766 (filed Nov. 21, 2014). Each of these provisional applications is incorporated by reference.

### FEDERALLY SPONSORED RESEARCH

Not applicable.

### BACKGROUND OF THE INVENTION

1. Field of the Invention

The present invention relates to data collection from remote locations. More specifically, the present invention is a system from collection operational data from processing and refinery plants and hydrocarbon storage tanks.

2. Description of the Related Art

Oil and natural gas wells, processing and refinery plants and storage tanks containing produced water, such as fracking fluids and others, are often located in extremely remote areas that are difficult to access and do not have adequate cell or internet coverage. Therefore, it has historically been difficult and expensive to manage all aspects of these sites in a timely and effective manner. Typically, technicians and engineers are required to make on-site inspections of each site in order to ensure that all equipment at the site are operating properly, record data from the site and to verify and/or diagnose operational abnormalities or failures. The vast number and remote locations of these sites, however, makes direct operational inspection on a regular basis extremely expensive for the companies that manage these sites.

In an attempt to mitigate these issues, some of these oil and natural gas sites have become equipped with remote transmitting units (RTUs) and/or controllers designed to collect and wirelessly transmit data from the sites to external processors, such as servers, for review and diagnosis by the operators. Indeed, the urgent need for improved data collection from these sites has led to a widespread proliferation of increasingly sophisticated RTUs, PLC transmitters and other SCADA-based (Supervisory Control and Data Acquisition) communications. However, these remote transmitter units are often still only capable of transmitting the most basic well or pump data and even those basic capabilities are often further limited by distances, weather and/or transmission ability. To improve upon the latter issue, cellular or other modern-based communication systems may be used in conjunction with the remote transmitting units. However, this option is extremely expensive to fully implement and, in some cases, not even a viable option in many of the remote areas where these oil and gas sites are located.

Another drawback with current methods of collecting and transmitting data from these remote locations is that the type of data that can be transmitted is limited. For example, many operational issues or failures can only be truly diagnosed or verified through visual inspection of certain portions of the well site. Existing transmitter units are unable to capture still images or standard or enhanced video around the well site and transmit these images to operators external to the site. In addition, many other operational issues or failures require sophisticated detection methods such as detecting airborne particulates in the ambient environment of a well site (e.g., hydrogen sulfide and/or hydrocarbons) or recording sounds from the well pump to determine its operational status. These detection methods currently require an operator to by physically present at the site.

Yet another drawback with current systems for managing gas and oil sites is that they are unable to immediately respond to, and/or mitigate, potential or actual failures of equipment at the site. To the limited extent that current systems are capable of transmitting operational failure data to a central collection location, there are no effective systems and methods for making operational changes at the site remotely. For example, if a failure status has reached a critical level that requires equipment to be immediately turned off or otherwise adjusted to limit or prevent damage occurring at the well site, an operator is required to drive to the site and physically turn off the equipment.

For these and other reasons, systems and methods are needed to remotely and cost-effectively gather more complete data from oil and natural gas well sites, refineries and/or remote fluid storage tanks.

### SUMMARY OF THE INVENTION

The present invention provides systems, devices and methods for collecting data from remote locations, such as oil and natural gas wells, processing and refinery plants, storage tanks for fluids, such as produced or recycled water, pipelines, nuclear reactors, coal mines, windmill farms, manufacturing production lines, research stations and the like. A system according to the present invention comprises a data transmitter and/or controller at the remote site and an unmanned aerial vehicle (UAV), such as a drone aircraft, configured to move to the remote location and connect with the data transmitter or controller to wirelessly receive and/or send data. The system further includes an external processor, such as a server, configured to wirelessly connect to the UAV to enable data transmission from the UAV to the processor. The UAV rapidly and cost-effectively moves to one or more remote site(s) and gathers significant data from the site(s) and then transmits that data to the external processor so that the operator is immediately aware of the operational status of each site and any potential or actual operational failures.

In one aspect of the invention, the remote site comprises an oil or natural gas well, an oil processing and refinery site or a fluid storage tank and the data may include a variety of important operational parameters, such as still and video images of the site, oil, produced water or other fluid tank levels, fluid pressures, fluid specific gravities and/or fluid leaks, airborne particulate concentrations, toxic or other gas concentrations, operational status or mechanical failures of selected equipment, such as pumps, drills and the like. The system preferably comprises software application(s) for automatically and routinely dispatching the UAV to one or more remote sites to perform data and/or image collection for subsequent relay or upload to the external processor. Alternatively, the UAV may be preprogrammed to move to a particular site or along a route that contains multiple sites. In yet another alternative, an operator may directly dispatch the UAV on-demand to a site through one or more user input devices, such as smart phones, computers, tablets or the like. The dispatch software may be directed from a ladder logic, SQL or other application or computer program, an internet or web-based browser user action(s) or process or other mobile platform user action(s) or process. In certain embodiments, the software is configured to relay global positioning satellite (GPS) or other geo-coded standards-based location data of the well or natural gas site and to cause the UAV to move to that location and perform data collection thereon.

In one embodiment, the UAV comprises a digital or analog connection receiver having a software application configured to make decision making processing, such as SQL, ladder logic, other “if-then” or “if-then-else” and the like, against the data transmitter and/or controller at the remote site. Data from the remote site, other than still or video images, will typically originate as a 4-20 mA analog signal or digital Modbus signal. Thus, the UAV is capable of determining the type of data standard used by the remote transmitter or controller at the remote site and adjusting to different standards, such as remote transmitting unit (RTU), programming logic controller (PLC), internet protocol (IP) based, supervisory control and data acquisition (SCADA) and the like. This allows the UAV to travel to and collect data from a large variety of different remote sites that may operate different data standards.

In certain embodiments, the UAV further comprises an image capture device, such as a camera, video player or other optical recorder, to capture still and/or video images of selected target areas of the remote site, and software designed to cause the UAV to move to the selected target areas for such image capture. The UAV further includes a software application coupled to the image capture device and configured to store the images for subsequent analysis by other software and/or inspection by the operator. In one embodiment, the storage application is configured to immediately transmit the images to the external processor for immediate operator review. This allows the operator to view selected target areas of the remote site almost in real-time so that management and operational decisions can be automated or otherwise made quickly and effectively.

In an alternative embodiment, the system comprises one or more sensor(s) configured to detect certain aspects of the ambient environment around the remote site. In one such embodiment, the sensor(s) are capable of detecting selected airborne particulates, such as hydrogen sulfide (H2S), oxygen, carbon dioxide, hydrocarbons (e.g., oil), radioactive particles, ammonia (NH3), sulfur dioxide (SO2), phosphine (PH3), arsine (AsH3), hydrogen cyanide (HCN) and the like, from the ambient air and/or equipment and storage tanks around the site. Alternatively, the sensor may be capable of detecting the actual concentrations of certain gases in the ambient air (e.g., Class I or Class II gases, methane gas, carbon monoxide (CO) or other toxic gases located at oil processing and refinery plants) to determine whether these concentrations are above prescribed standards. The UAV is further configured to transmit information regarding these airborne particulates and/or gas concentrations to the external processor. This allows the operator to determine whether an unsafe amount of these particles has leaked at the remote site (e.g., from a well, nuclear power plant or the like) or whether certain gas concentrations are too high (e.g., methane gas that is being burnt off at the site).

In one aspect of this embodiment, the sensor(s) are located on the UAV and the UAV is configured to travel to selected locations that would allow the sensor(s) to detect selected airborne particulates and/or gas concentrations. In another aspect, one or more sensor(s) may be located at the remote site and may be coupled to the data transmitter and controller or they may be configured to transmit the data directly to the UAV. In the latter configuration, the UAV may be programmed to move to each of the sensor locations to collect the data via WI FI, Bluetooth, microwave, radio or cellular transmission, image or video capture or the like.

In another aspect of the invention, the UAV further comprises a logic-based application configured to analyze and make decisions based on the data collected from the remote site. The UAV may further comprise a software application configured to wirelessly transmit data or instructions regarding operating parameters of the remote site to the remote transmitter based on the decisions made by the logic-based application. The software application may be part of the logic-based application or it may be a separate software application coupled thereto. In certain embodiments, the software application will actually transmit commands or instructions to the data transmitter or controller or directly to other processors or equipment at the remote site. In other embodiments, the software application will transmit data that allows the controller at the remote site to make certain decisions regarding operating parameters (e.g., transmit data that causes a logic-based application within the remote site controller to perform an operation). This feature allows the UAV to immediately analyze data from the remote site and provide appropriate commands or instructions to the remote controller to change operating parameters at the site.

In some embodiments, the UAV will automatically transmit the data to the external processor and wait for commands or instructions from the external processor or other user-directed action. In these embodiments, the decisions may be made by operators viewing the data from the external processor, or the decisions may be made automatically by the external processor. In the latter configuration, the external processor may comprise one or more servers that contain their own logic-based software that are capable of making decisions based on the collected data. The system may, in fact, comprise multiple UAVs that are collecting data from one or more remote sites and transmitting this data to a central server or cloud that correlates the data and makes decisions to change operating parameters accordingly.

In other embodiments, the UAV will comprise software capable of making the decisions and issuing the instructions or data by itself. This feedback control allows the UAV to, for example, immediately shut down a pump that has failed or is operating outside of safe or cost-effective parameters, or to immediately cease the release of H2S at a well site or methane gas burning at a natural gas site if the concentrations of methane gas become dangerously high or above prescribed parameters. Since the UAV(s) are capable of collecting data 24 hours a day and through inclement weather conditions, this feature allows the operator to monitor sites, collect data and safely control or shut down equipment during times that would be difficult, if not impossible, for human operators to do so.

In another alternative embodiment, the system further comprises one or more audio sensor(s) configured for attachment to a pump, pipeline or other critical equipment at the remote site. The audio sensor is further configured to transmit one or more audio file(s) to the UAV either directly through Bluetooth, WI FI, image or video capture or the like or through coupling to the data transmitter or remote controller. The UAV is configured to transmit the audio file to the external processor to allow the operator to listen to the audio file and determine if the pump or other critical equipment is operating within selected parameters. In certain embodiments, the UAV may include or have access to a software application configured to analyze the audio file and make decisions regarding those operating parameters. The software application may be further capable of transmitting data or instructions to the remote site to change operating parameters of the pump, pipeline or other critical equipment based on such decisions. In another embodiment, the audio file will be uploaded and transmitted to the external processor, which can comprise one or more servers capable of making such decisions and transmitting such instructions, or for operator review and diagnosis.

Alternatively, the UAV itself may comprise one or more audio sensors for detecting sounds around the remote site and recording those sounds on audio file(s) that can be stored within the flight controller of the UAV. In this embodiment, the UAV may include or have access to a software program that causes the UAV to move to selected locations at the site and then listen to, and record sound from, those locations. The UAV may further comprise a number of sound filters, such as ambient noise filters or rotor noise filters, to enhance the quality of the audio video.

In yet another aspect of the invention, the UAV may comprise a fluid level monitor for measuring the fluid level of fluids in storage tanks at remote sites, such as produced (e.g., fracking) water and the like. The fluid level monitor may comprise a microwave or infrared transmitter on the UAV for directly measuring the fluid level in the tanks. Alternatively, the fluid level monitor may comprise a float level sensor located in the storage tanks and means for collecting data on the float level from this sensor, such as a transmitter coupled to the float level sensor (e.g., Bluetooth, WI FI or the like) or a display image of the float level above the storage tank than may be captured by the image capture device on the UAV.

In another aspect of the invention, the remote site comprises a manufacturing production line, wherein the data and image or video primarily comprises those moving elements essential for subsequent computer processing or analysis. A plurality of UAVs may be used, for example, to quickly and accurately inspect parts in the production line in lieu of human operators.

In a method of collecting data from a remote site according to the present invention, a UAV moves to the remote site, collects data and then wirelessly transmits the data to an external processor. Alternatively, if the UAV does not immediately have wireless access to the external processor, the UAV will store the data and transmit it when such access is available. The UAV may be dispatched to the site by the external processor, or it may move to the site as part of a pre-programmed route. For example, the UAV may be provided with a pre-programmed route that moves it to a plurality of remote site according to a selected time schedule. In one embodiment, the remote site comprises an oil or natural gas well or processing and refinery site and the UAV is configured to detect operational data from this site to allow for cost-effective and safe management of the site.

In one embodiment of the method, the UAV moves to target locations around the remote site and captures still or video images of those target locations to transmit them back to the external processor. The UAV may also connect to a remote transmitting unit (RTU) at the site and capture data directly from this RTU. In certain embodiments, the UAV further detects selected information about the ambient environment around the well site, such as airborne particulates (e.g., hydrogen sulfide, hydrocarbons, radioactive particles and the like) or toxic gas concentrations, such as methane gas or others. In this embodiment, the UAV may directly sense this ambient information or it may be designed to receive the data from sensors positioned at selected locations around the remote site. In other embodiments, the UAV collects audio files from the sites containing sound data on selected equipment, such as a pump. The audio files may be analyzed by the UAV or wirelessly transmitted back to the external processor and/or a user input device, such as a smartphone, computer and the like, for analysis or diagnosis.

In one embodiment of the method, the UAV analyzes the data collected at the well site and makes logic-based decisions based on such data. The UAV then transmits data or commands to the well site to change one or more operating parameters at the site. For example, the UAV may analyze hydrogen sulfide particles and determine that the concentration of such particles are too high for safe operating conditions. In this example, the UAV may automatically transmit data or instructions to shut-down the well to avoid safety hazards at the site and allow operators to safely diagnose operational failures at the well site. Alternatively, the UAV may transmit the data to the external processor and/or user input and then relay instructions from the processor or user input to the remote site. In this embodiment, the external processor may comprise one or more servers comprising one or more software applications configured to make logic-based decisions based on collected data.

In yet another aspect of the invention, a UAV, such as a drone aircraft, is provided for collecting data from remote sites, such as oil and natural gas wells or refinery and processing plants. The UAV comprises a software program configured to receive dispatch information from an external processor and to move to one or more remote sites based on the dispatch information, a connection receiver configured to wirelessly connect to a remote transmitting unit and/or controller at the site and a transmitter or antenna configured to relay the data to an external processor and/or user input. In certain embodiments, the UAV will further comprise an image capture device, such as a camera or video recorder, for capturing still or standard or otherwise enhanced video images at selected locations around the site. In other embodiments, the UAV may comprise a sensor configured to detect ambient air data around the site, such as airborne particulates and/or gas concentrations, a fluid level monitor configured to determine fluid levels within storage tanks and the like and/or an audio sensor for detecting sound emanating from selected locations around the remote site and converting the sound into an audio file for analysis and decision making.

Preferably, the UAV further comprises a logic-based software application configured to analyze the data collected from the site and to make decisions based on such data and a command software application linked to the logic-based application (or integral with such application) and configured to transmit data or instructions to the site to change one or more operating parameters at the site. This allows the UAV to make immediate changes in operating parameters at the site one data, such as gas or fluid leaks or other changes in the ambient environment indicating that the equipment is not operating within design parameters.

In another aspect of the invention, a UAV comprises one or more antennas for receiving communications from cellular, data, cable or internet signals and one more transmitters or antennas for relaying these signals. In this embodiment, the UAV serves to augment other third-party carrier networks for purposes or relaying wireless phone, cable, internet and/or data network services. The UAV may further comprise an on-board relay hardware/software application that can be coupled to cellular and/or WI FI networks so that the UAV is used as a proxy for a cellular tower, satellite, wireless, internet access or other data serve transmitter. The transmitter(s) on the UAV may be connected to the primary carrier either directly or via another UAV acting as another proxy relay, thus forming a peer to peer carrier network. In such a network, a plurality of UAVs are established in blank spots or “holes” in cellular coverage (e.g., between cellular towers in remote areas). A cellular signal in these areas usually will not be strong enough to find a cellular tower and, therefore, the user will not have a signal (e.g., “zero bars”). However, with the peer to peer network of the present invention, the cellular signal will be received by one of the receivers on one of the UAVs in the network. The UAV will then send out signals that search for either another relay UAV or the primary carrier until the signal eventually finds its way to the primary carrier. Alternatively, the one or more series of UAVs may act as wireless or WI FI “hotspots” allowing a wireless phone, laptop or tablet to use an IP-based data connection in lieu of, or in addition to, a typically expected cellular connection.

In this embodiment, the UAVs may each comprise transponders to allow the operator to immediately locate each UAV in the absence of other GPS information and to redirect them to cover blank spots or holes in cellular or network coverage. In addition, the UAVs may further comprise collision avoidance software that recognizes other flying objects, such as the other UAVs in the peer to peer network, airplanes or the like and tall objects, such as buildings or mountains, and automatically redirects the UAVs to avoid collision with such objects. This allows the operator to effectively and safely manage, and automatically adjust when necessary, a plurality of UAVs in remote areas.

The novel systems, devices and methods for collecting data at remote sites according to the present invention are more completely described in the following detailed description of the invention, with reference to the drawings provided herewith, and in claims appended hereto. Other aspects, features, advantages, etc. will become apparent to one skilled in the art when the description of the invention herein is taken in conjunction with the accompanying drawings.

### BRIEF DESCRIPTION OF THE DRAWINGS

FIG. 1 is a schematic view of an unmanned aerial vehicle (UAV) according to the present invention.

FIG. 2 illustrates an exemplary image capture device on the UAV of FIG. 1.

FIG. 3 is a schematic view of the UAV of FIG. 1 collecting data from a plurality of remote sites and transmitting the data to an external processor according to a method of the present invention.

FIG. 4 is a flow diagram of a system for collecting data according to the present invention.

FIG. 5 is a flow diagram of an alternative embodiment of the system of FIG. 4 comprising a feedback control mechanism.

FIG. 6 is a flow diagram of another alternative embodiment of the system of FIG. 4 comprising one or more sensor(s) for detecting information about the ambient environment around a remote site.

FIG. 7 is a flow diagram of another alternative embodiment comprising one or more sound recording sensor(s) according to the present invention.

FIG. 8 is a flow diagram of another alternative embodiment comprising one or more flow level detector(s) for measuring fluid levels in storage tanks of remote sites.

FIG. 9 is a schematic diagram illustrating a variety of alternative external processing devices and user input devices for use with the various embodiments of the invention.

FIG. 10 is a flow diagram of a signal transmission relay system according to the present invention.

### DETAILED DESCRIPTION OF VARIOUS EMBODIMENTS

For the purposes of promoting or understanding of the principles of the invention, reference will now be made to the embodiments, or example, illustrated in the drawings and specific language will be used to describe the same. It will nevertheless be understood that no limitation of the scope of the invention is thereby intended.

In accordance with the teachings of the present invention and as discussed in more detail presently, systems, devices and methods are provided comprising one or more unmanned aerial vehicles (UAVs) or other drone aircraft, for the purpose of collecting data from remote sites, such as oil and natural gas wells, processing and refinery plants, produced water (e.g., fracking water and the like) storage areas, windmill farms, nuclear reactors, coal mines, research stations, pipelines or other remote sites wherein cellular or other signal transmissions are limited or completely absent. In the embodiments described hereinafter, the systems and methods disclosed herein employ both the automated and user-directed dispatch of a UAV as part of a monitoring and support process for oil and natural gas wells, refineries or produced water storage areas.

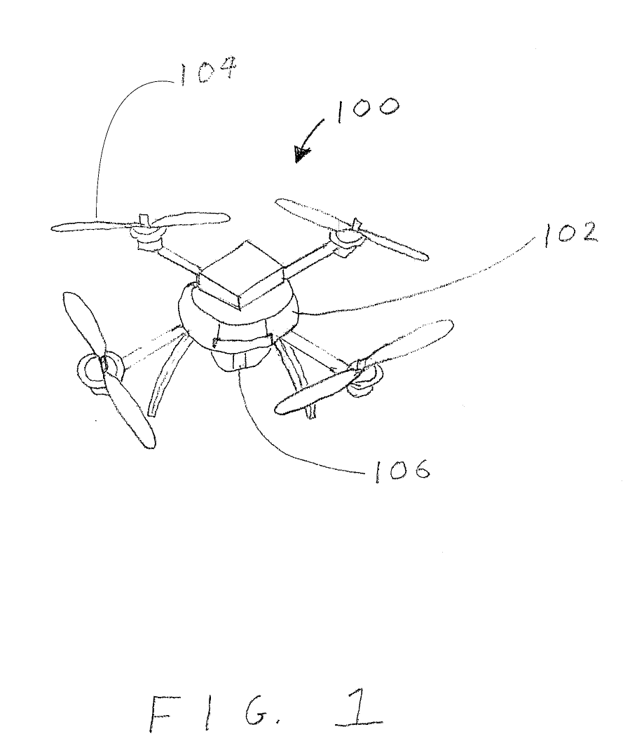

Referring now to FIG. 1, a UAV 100 according to the present invention comprises a body 102 and a plurality of rotors or propellers 104 surrounding body 102. UAV 100 will typically comprise 2-8 rotors 104 that allow UAV to move in any direction and to hover at a selected location. UAV 100 further comprises one or more motors (not shown) for driving rotors 104 and a power supply (also not shown) within body 102 for supplying power to the motor(s) and all on-board electrical systems. The power supply typically comprises one or more rechargeable batteries, such as LiPO, lithium-ion, Li, FePo, F4c, NiCad batteries and the like. Alternatively, UAV 100 may be powered by other means, such as solar power, wind power, hybrid electric-battery power, gas or other fossil fuels and the like. UAV 100 is designed to recharge its power supply at a power base 205, which may comprise a standard electrical charging pad, solar-powered charging pad, gas-powered, hybrid pad or the like. The power base 205 may be located at each of the remote sites, or at a position suitably located as to allow UAV 100 to travel to the remote site(s) and back to base 205 with sufficient power to gather data at each remote site. In certain embodiments, UAV 100 may be designed to recharge wirelessly without actually being in physical contact with its base 205.

An exemplary UAV 100 that may be used in conjunction with the present invention is more fully described in the technical and operational manual for the 3D Robotics and/or Service-Drone eight rotor (or octorotor) UAV, the complete disclosure of which is hereby incorporated by reference in its entirety for all purposes. Of course, it will be understood by those of skill in the art that a variety of different types of UAVs or drones may be used in conjunction with the present invention, e.g., a DJI, Parrot Drone or other suitable UAVs known in the art. In addition, although a rotorcraft-type UAV is shown in FIG. 1, other types may be used, such as flying or fixed wing, blended wing or the like. However, rotorcraft-type vehicles are presently preferred for the present invention as they provide the ability to hover in a single location for the collection of certain data, image or video capture and the like.

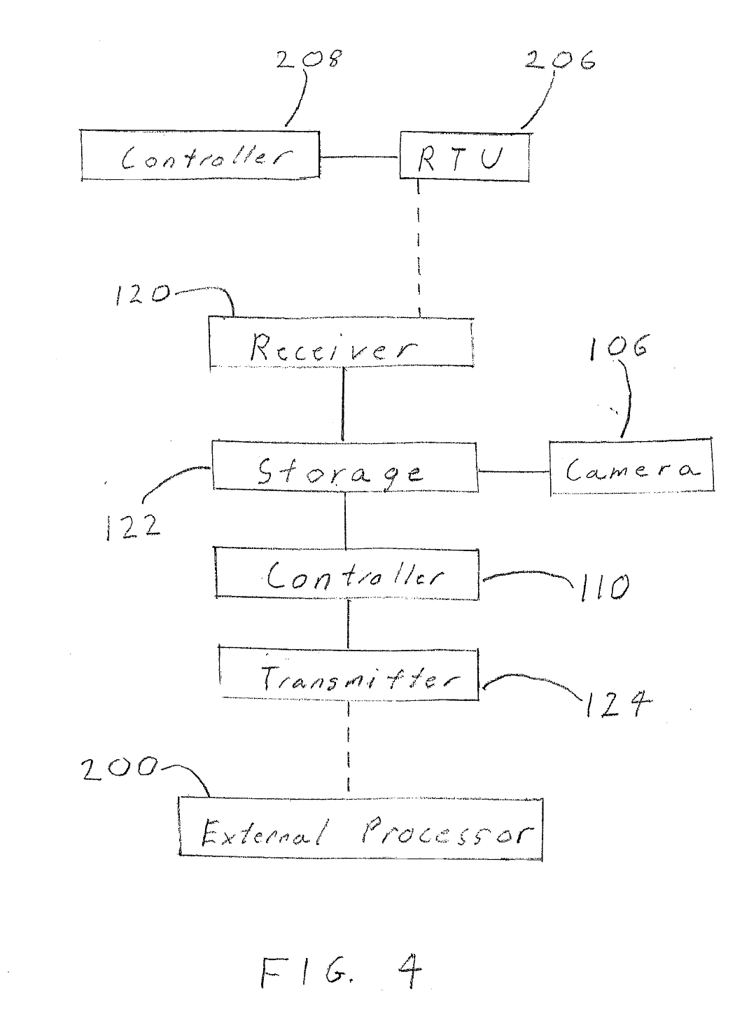

UAV 100 further comprises a flight controller 110 (see FIG. 4) which preferably includes an on-board flight computer such as the PIXHAWK® flight controller system, manufactured by 3D Robotics, Inc. of Berkeley, Calif., or other suitable flight controllers known to those of skill in the art. Flight controller 110 typically comprises flight navigation software, autopilot functions, such as scripting of missions and flight behavior and altitude and airspeed sensing software and may be coupled to various accelerometers, magnetometers, IMIJ compasses, GPS or other geo-coded sensors, airspeed sensors, altimeters, temperature and barometric pressure sensors as well as other environmental sensors to facilitate directional control of UAV 100 either directly by an external processor (not shown in FIG. 1) or through an autopilot program that delivers GPS or other geo-coded instructions through software applications to flight controller 110.

UAV 100 preferably comprises a GPS module and a plurality of servos coupled to one or more receivers and transmitting antennas (not shown) that allow UAV 100 to automatically fly to selected locations based on input from the external processor or operator. Those of skill in the art will understand that a variety of different systems may be employed to autopilot UAV 100. In some embodiments, UAV 100 may include a transponder, such as the Sagetech XPS-TR ADS B transponder (not shown) that will allow third parties (such as air traffic control) to keep track of its location in flight. UAV 100 may also include one or more software program(s) that automatically direct UAV 100 to return to its base if, for example, the battery power runs low to avoid crashing and/or if the UAV has executed the autopilot command or program and has not received any further instructions (e.g., if the UAV is no longer receiving signal transmissions from its base). UAV 100 may also include a crash avoidance software application that overrides its autopilot software and alters its route if this route will cause UAV 100 to come too close to another flying object or man-made structure.

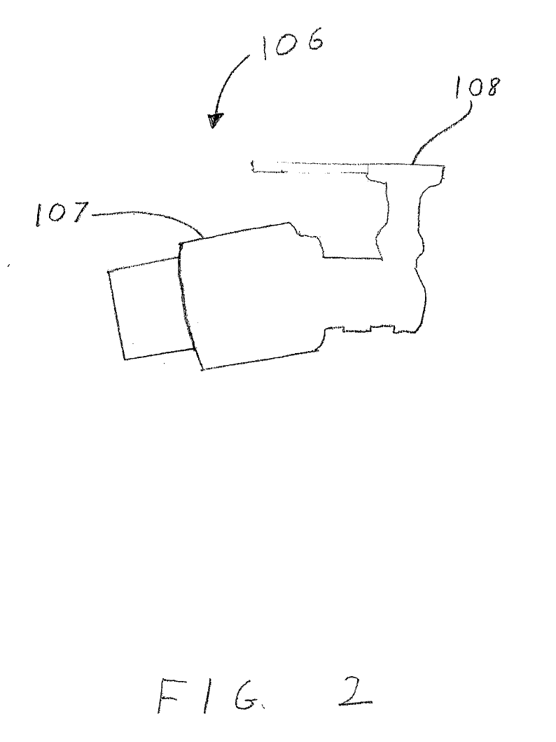

One or more video camera(s) 106 are preferably mounted to body 102 of UAV 100 to capture still and video images of the remote sites. An exemplary high-resolution video camera 106 is illustrated in FIG. 2. In one embodiment, video camera 106 has standard pan, tilt and zoom (PTZ) features. It will be recognized by those of skill in the art that a variety of commercially available video cameras may be used with the present invention, such as those manufactured by GoPro, Mobius, Contour, Sony, Keychain, Sandisk and the like. Alternatively, video camera 106 may comprise a thermal, starlight ambient, hyperspectral imaging or infrared camera for capturing images without sufficient sunlight available (i.e., at night or inclement weather), for capturing images of stress fractures in structures (e.g., in windmills) and/or for capturing thermal data at remote sites, such as storage tanks and the like. One such hyperspectral camera that is particularly suited for these purposes is the OVI-UAV-1000, manufactured by BaySpec, Inc. of San Jose, Calif. Video camera 106 is preferably mounted to a gimbal mount 108, allowing camera 106 almost 90 degrees of motion around three axes. Video camera 106 is coupled to a digital or analog storage application 122 (see FIG. 4) of flight controller 110 or onboard computer (discussed in detail below) for storing still or video images that may be immediately uploaded and transmitted to an external processor and/or stored for transmission when UAV 100 returns to base. Video camera 106 may also include enhanced optical video wherein the video primarily comprises moving elements in a manufacturing production line that may be imaged for subsequent or immediate computer processing and analysis. Video camera 106 is also preferably coupled to the GPS module and various servos to provide location information so that UAV 100 and/or the external processor can ensure that images are captured at the desired locations around the remote site.

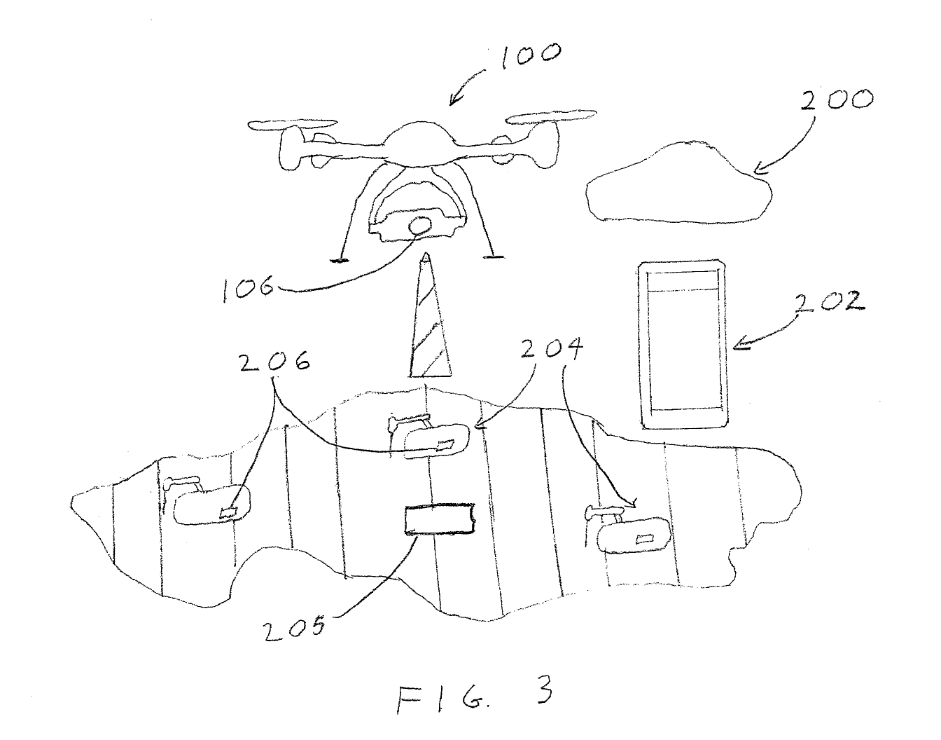

Referring now to FIG. 3, a schematic view of a system for collecting data according to the present invention is illustrated. As shown, UAV 100 comprises one or more receivers and one or more transmitters or antennas (not shown) coupled to an external processor 200, such as a telemetry cloud, SPL or other external processor via WI FI, cellular, radio, satellite, microwave or other suitable signal transmission. In one embodiment, external processor 200 comprises one or more cloud-based network server and storage devices, although it will be recognized by those skilled in the art that a variety of different types of processors with different configurations may be used in conjunction with the present invention, such as server space accessed via cloud computing apparatus and the like. External processor 200, in turn, is coupled to one or more user input devices 202, such as computers, mobile phones (e.g., Apple iPhone, iOS or Google Android-based interfaces), tablets or the like, for relaying data from UAV 100 to user input devices 202 and for transmitting instructions from the operator to UAV 100. UAV 100 and/or processor 200 preferably comprise software application(s) for consolidating and displaying the collected and collated field data from the remote sites onto user input device(s) 202.

UAV 100 may be dispatched automatically through one of a variety of computer programs, such as Drone Deploy® by Infatics, Inc. of San Francisco, Calif., ladder logic, SQL or the like, internal computer application(s) or other web-based browser user action(s) or processes, other object-based or scripting process, and/or a mobile phone or other mobile platform user action or process. For example, a routine flying pattern of UAV 100 may be performed upon a scheduled pattern for purposes of gathering data from a plurality of remote sites 204. At the time of the automated dispatch of UAV 100 from the automated dispatch program, GPS or other geo-coded standards based location data of the remote site 204 is relayed to flight controller 110 on UAV 100. UAV 100 is then dispatched to the remote site 204 (e.g., a natural gas or oil well). In this example, UAV 100 will be directed to fly to one or more well sites 204 to perform routine daily data collection from a remote transmitter 206 and/or remote controller 208 (see FIG. 4) located at each of the well sites 204. Alternatively, UAV 100 may be dispatched on-demand to a non-functioning or inadequately functioning well site.

In one embodiment, UAV 100 comprises a digital connection receiver 120 (see FIG. 4) that employs a sophisticated combination of server-based software that is configurable to allow standard SQL, ladder logic, or other “if-then” or “if-then-else” type decision-making processes to be performed against the database of remote controller 208. In addition, UAV 100 is designed to move to selected locations about each of the remote well sites 204 to perform still and video (standard or enhanced) image capture of the selected locations. The data received from remote transmitter 206 and/or remote controller 208 and the captured images from camera 106 are gathered and stored in a digital storage application 122 (see FIG. 4) within UAV 100 for subsequent and/or immediate relay and transmittal to external processor 200.

In methods of the present invention, UAV 100 is directed to a well site 204, either automatically through a decision-based computer program, or from user action via user input device 202. UAV 100 flies to a location in close enough proximity such that flight controller 110 can employ digital connection receiver 120 to establish a digital connection with one or more remote transmitters 206 at the well site 204. This connection may be one or more combinations or an industry standard WI FI or other extension of the 802.11 wireless protocol communication standard, other Internet Protocol-based (IP) networks, cellular, Bluetooth, satellite, microwave, radio or other wireless standard protocol. UAV 100 comprises a computer application and/or system for connecting to remote transmitter 206 via one of these protocols, wherein controller 110 receives and digitally stores data from remote transmitter 206, which may comprise Modbus transmitters, PLC transmitters, RTUs, SCADA-based, or other digital or analog data broadcasters located at or near oil and natural gas sites.

In one example of operation of the present invention, UAV 100 performs daily pre-programmed surveillance of a remote well site 204 and captures images of the pump jack (not shown) at the well site. The video is uploaded through processor 200 and user input devices 202 to trained personnel for instantaneous review for abnormalities in the pump jack operation. After this review, any abnormality (e.g., pump is impaired function or has completely ceased activity) can be reported to the designated field production engineer for review via the processor cloud on his/her mobile device. After making a preliminary determination, the field engineer or operator provides instructions through processor 200 to UAV 100 to capture a close-up visual inspection at a specific location on the pump jack to confirm the suspected problem. Once this image has been captured, stored and transmitted back to the operator, he/she is able to confirm the preliminary failure analysis and dispatch personnel to fix the problem.

Referring now to FIG. 4, a schematic view of a system of the present invention is illustrated. As shown, UAV 100 comprises digital receiver 120 and camera 106 coupled to digital storage 122 and flight controller 110. Digital receiver 120 is configured to connect to remote transmitter 206 at the remote site 204 and to receive data from transmitter 206. In the embodiment, digital receiver 120 receives the data through universal WI FI, although it will be recognized that other signal transmissions are possible, such as Bluetooth, cellular, microwave, radio, satellite or the like. In some cases, remote transmitter 206 is coupled to a remote controller or computer 208 which serves to manage the data collected at the site 204 and to transmit the data to the remote transmitter 206. In other cases, transmitter 206 and controller 208 will be integral with each other (i.e., the same device) and/or the remote site 204 will not include a controller 208.

Digital storage 122 receives data from digital receiver 120 and images from camera 106 and stores these data either for immediate use by UAV 100 (discussed further below) or for transmittal to external processor 200. Digital storage 122 preferably comprises server space accessed via a cloud computing apparatus. In certain embodiments, UAV 100 does not contain digital storage 122 and data is immediately processed and then transmitted by flight controller 110. Flight controller 110 preferably comprises a processor or computer designed to run multiple software applications and to manage data flow within UAV 100. UAV 100 further comprises one or more transmitter(s) 124 coupled to flight controller 110 for transmission of data to external processor 200. Transmitter(s) 124 preferably comprise one or more antennas designed to transmit data via suitable signals, such as microwave, radio, cellular, WI FI, Bluetooth or the like. The antenna(s) may comprise an omni- or bi-directional industry standard antenna or other suitable antenna known to those of skill in the art. If a cellular or data carrier network is currently unavailable, the data may be temporarily stored on UAV 100 for later transmission through transmitter 124 when it becomes available.

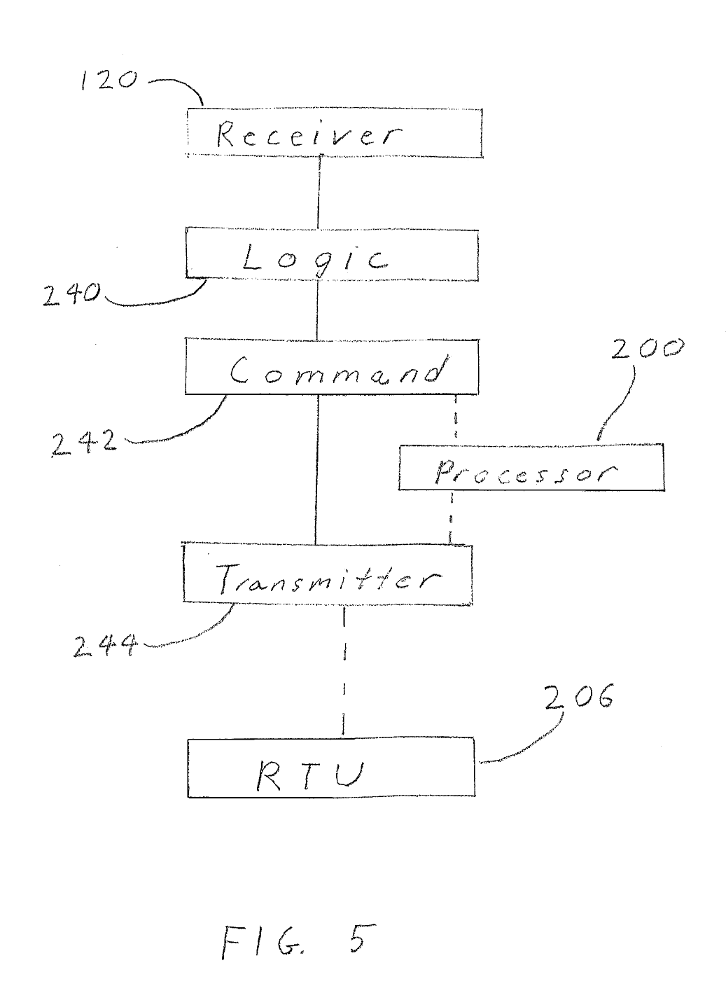

An alternative embodiment of the present invention is schematically illustrated in FIG. 5. As shown, UAV 100 comprises a decision-based logic application 240 integral with, or coupled to, flight controller 110. Logic application 240 is configured to review the collected data from the remote site and make decisions based on this data. Logic application 240 may be coupled directly to receiver 120 or it may be coupled to digital storage 122 (see FIG. 4). A command application 242 is coupled to decision-based logic application 240 and is configured to prepare data and/or instructions for transmittal by transmitter 244 to remote transmitter 208 at the site. Command application 242 may be part of logic application 240 or they may be separate software programs linked together within flight controller 110. An exemplary logic application 240 and command application 242 are DroneDeploy action software combined with custom Linux-based applications or related scripting or programming.

In this embodiment, UAV 100 provides a feedback loop that enables the system to change the operating parameters at the remote site based on the data collected therefrom. In one embodiment, command application 242 directly transmits instructions to remote transmitter 208, which comprises one or more receivers or antennas (not shown) for receipt of said instructions. The instructions are then relayed to controller 208 for implementation at the remote site. For example, data received from transmitter 208 may indicate that one or more pieces of equipment, such as a pump, at the well site is not operating properly and represents a safety or operating hazard to the site. In this example, logic application 240 gathers this data and makes a decision based on its programmed logic and transmits this decision to command application 242. Command application 242 then generates data or instructions based on the logic decision. The instructions may contain information causing the remote controller 208 to change the operating parameters of the equipment and/or shut the equipment down for further inspection or repair by the operator. Alternatively, the data received may indicate that certain information about the ambient environment around the remote site (e.g., airborne particulates and/or toxic gas concentrations as discussed in more detail below) is outside of operating parameters.

In an alternative embodiment, the instructions from command application 242 may simply comprise data that is transmitted to controller 208 via the receiver at the remote site. In this embodiment, controller 208 contains its own decision-based logic application (not shown) configured to make decision based on the data received from UAV 100. Thus, for example, if UAV 100 or logic application 240 makes the decision to shut down certain equipment, such as the well pump, it may transmit selected data that is received by remote transmitter 206 and read by controller 208. Controller 208 is programmed to then make the operating decision to shut down the pump based on the received data.

In another embodiment, logic application 240 and command application 242 are located at the external processor 200 instead of, or in addition to, the UAV 100. In this embodiment, UAV 100 acts to simply relay data from the remote site to external processor 200. External processor 200 then makes certain automatic decisions based on the data and issues commands, instructions or data back to UAV 100. UAV 100 then relays these instructions to transmitter 206 and/or controller 208 at the remote site to change the operating parameters at the site. These decisions made by the external processor 200 may be made automatically based on preprogrammed software or they may be made by the operator reading the data. In the latter case, external processor 200 transmits the data to user input 202 (e.g., a mobile phone) where the operator may view or read the data and then make suitable decisions to change operating parameters at the remote site. In this case, user input 202 will comprise a software program enabling the operator to issue instructions through user input 202 to external processor 200 which, in turn, relays these instructions through UAV 100 to remote transmitter 206 at the site.

The feedback features of the present invention allow for real-time changes in operating parameters at remote sites. This has the advantage that these operating decisions will be made quickly and efficiently without requiring an operator to physically travel to the remote site.

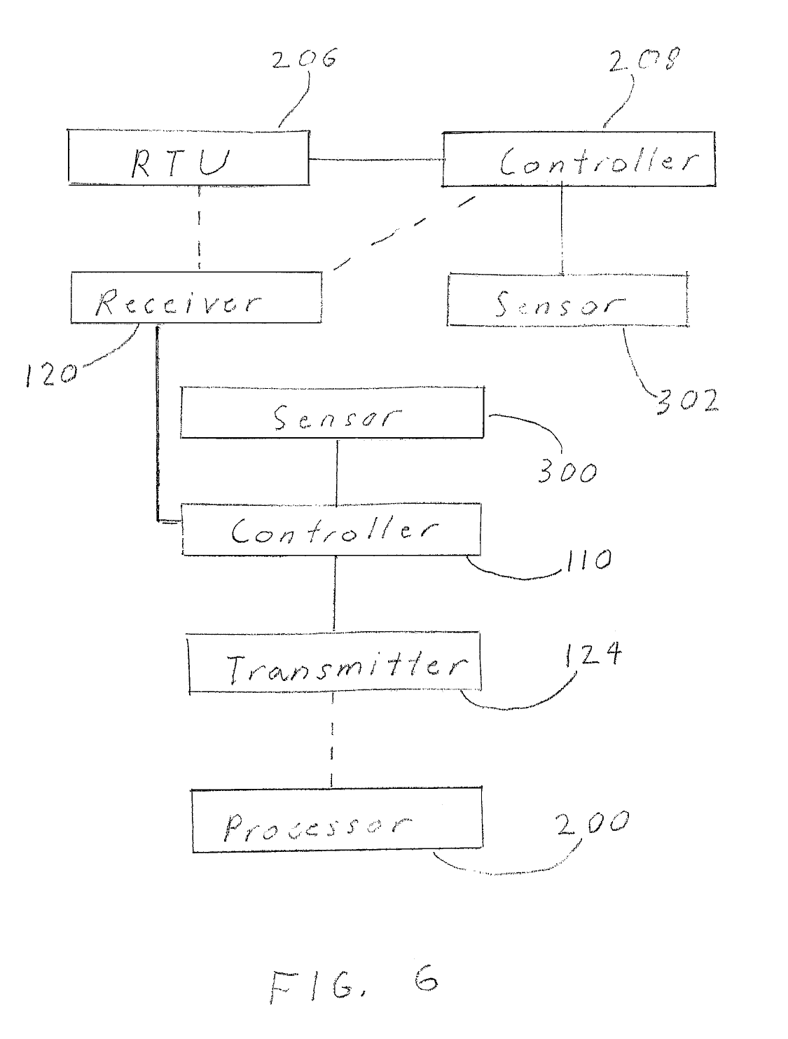

Referring now to FIG. 6, another alternative embodiment of the present invention is schematically represented. As shown, UAV 100 comprises one or more sensor(s) 300 preferably located on portions of body 102 (see FIG. 1). These sensors 300 are designed to collect data directly from the selected locations of the remote site (i.e., without the need for transmission of data from remote transmitter 206). Many oil and natural gas well sites are not currently equipped with a remote transmitter 206 or controller 208. In these cases, UAV 100 will employ sensors 300 to directly collect this data without requiring an operator to visit the site.

In one aspect of this embodiment, sensor (s) 300 comprise gas monitoring sensors designed to detect certain toxic gas concentrations and/or airborne particulates in the ambient environment around the site, such as hydrogen sulfide (H2S), arsine (AsH3), ammonia (NH3), phosphine (PH3), hydrogen cyanide (HCN), sulfur dioxide (SO2), carbon monoxide (CO), methane, oxygen, carbon dioxide, hydrocarbons (e.g., oil), radioactive particles, and other combustibles or toxics. Sensor(s) 300 detect this data and transmit it to flight controller 110, which can then transmit the data to external processor 200 and/or make decisions based on the data as discussed above in reference to FIG. 5. For example, hydrogen sulfide is often generated at oil and gas wells and the quantity of hydrogen sulfide (H2S) in the ambient environment is a sign of potential catastrophic failure of the well. Sensor(s) 300 can detect the amount of hydrogen sulfide in the air around the well site so that appropriate operating parameters can be immediately changed to either reduce the leakage, shut down the well, call an operator to respond and inspect the well or the like.

Alternatively, and/or additionally, sensor(s) 302 may be located at various locations around the remote site. In this embodiment, sensor(s) 302 are preferably coupled to remote transmitter 206 (either directly or through controller 208) such that the data detected by sensor(s) 302 can be transmitted to UAV in a similar manner as described above. Suitable gas monitoring sensors that can be used in conjunction with the present invention are the RKI MWA™ or the RKI M-Series sensors manufactured by RKI Instruments, Inc. of Union City, Calif. However, it will be recognized by those skilled in the art that other commercially available gas monitoring sensors may be used with the present invention.

In another aspect of the invention, sensors 302 are not directly coupled to either a remote transmitter 206 or a controller 208 at the remote site. In these embodiments, sensors 302 may include a transmitter (not shown) configured to transmit data on gas concentrations and/or airborne particulates via Bluetooth, WI FI or the like. The data may be transmitted to controller 208 for subsequent upload to UAV, as described above. Alternatively, UAV 100 may comprise a receiver (not shown) for directly receiving data transmissions from sensors 302. In this latter embodiment, for example, UAV 100 may be directed or pre-programmed to fly to a location near each of the sensors 302 to receive data transmission, e.g., Bluetooth, from the sensors 302. In yet another alternative embodiment, sensors 302 may include a digital or analog display of data regarding selected gases and UAV 100 may capture an image of the display for storage and/or transmission to external processor 200.

UAV 100 may further include a magnetic field generator (not shown) coupled to flight controller 110 for calibrating sensor(s) 302. In this embodiment, the magnetic field generator may be used as a “magnetic wand” to recalibrate sensors and/or to change the alarm settings for certain sensors. For example, a sensor may be set to produce an alarm when hydrogen sulfide levels reach a certain assumed critical level. However, in certain locations and environments, the assume critical level may fall within normal operating parameters. UAV 100 is configured to constantly monitor these levels and to recognize when the critical level should be changed to mitigate false alarms.

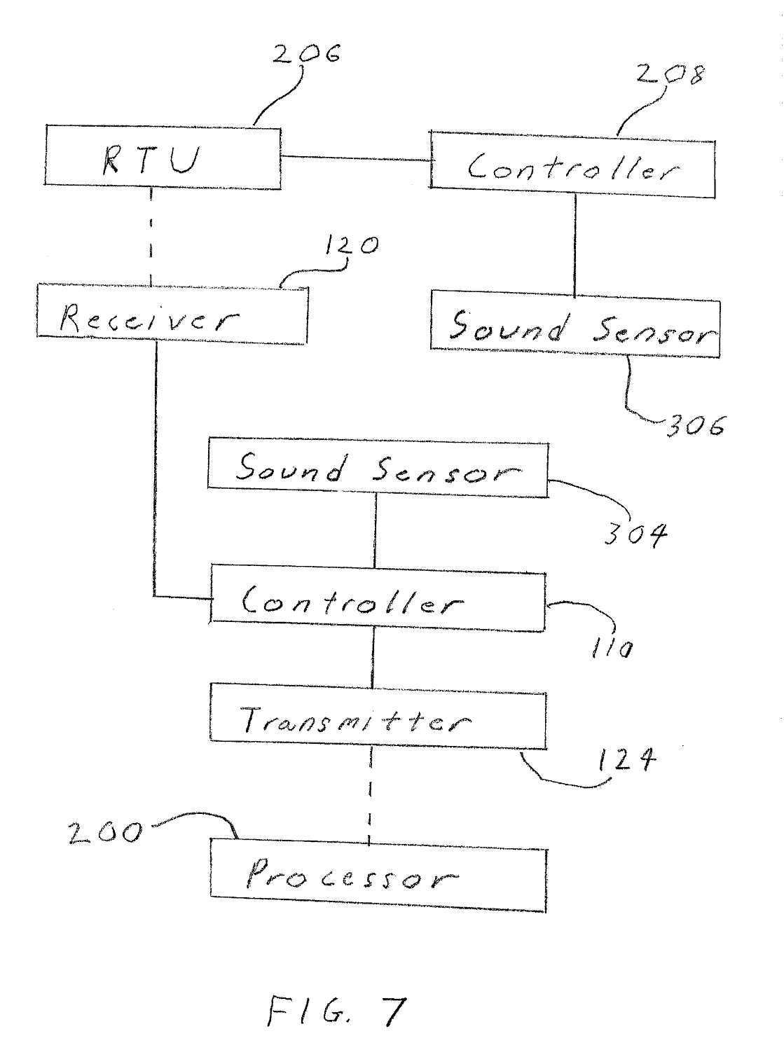

Referring now to FIG. 7, another embodiment of the present invention provides the UAV 100 with the ability to listen to certain equipment at the remote site and to transfer audio files to the external processor 200 and/or operator. Preferably, one or more sound sensor(s) 204 are mounted on body 102 of UAV 100. These sound sensors 304 are coupled to a sound recorder (not shown) configured to record sounds onto an audio file (also not shown), store the audio file and transmit the audio file to flight controller 110. Alternatively, the sound may be transmitted directly to digital storage 122 and/or flight controller 110, where it is then stored on an audio file. UAV 100 may further comprise digital or analog ambient noise filters coupled to sound sensors 304 or the sound recorder and designed to filter out certain sounds, such as noise from the rotors 104, or other ambient background noise that would detract from the desired recording. Flight controller 110 is designed to either make decisions based on the contents of the audio file and/or to transmit the audio file to external processor 200. For example, sound sensors 304 may be designed to detect sounds emanating from a pump at the well site. The system and/or operator can listen to the audio file of the pump noises to determine if the pump is operating within prescribed parameters. In this embodiment, UAV 100 will be automatically programmed, or manually directed, to fly adjacent to or near the relevant equipment (e.g., the pump) so that sound sensors 304 may pick up the sound emanating from the equipment.

Alternatively, and/or additionally, one or more sound sensors 306 may be located at various locations around the remote site, e.g., on the pump itself. In this embodiment, sound sensors 306 may be coupled to remote transmitter 206 (either directly or through controller 208) such that the detected sound is recorded to audio files, stored and transmitted to UAV 100. Sound sensors 306 may be hardwired to controller 208 or they may be wirelessly coupled through Bluetooth, WI FI or the like. In this embodiment, sounds sensors 306 each comprise their own sound recorder so that a recorded audio file may be wirelessly transmitted to the remote controller 208. Similarly, the audio file may be transmitted directly to UAV 100 (i.e., bypassing controller 208 entirely). In this latter embodiment, UAV 100 comprises a receiver (not shown) for picking up the Bluetooth or WI FI signal from each sound sensor 306. In this manner, UAV 100 may collect data from sound sensors 306 in remote areas that do not have a controller 208 or an RTU 206. Suitable technology for detecting and transmitting sound recordings via Bluetooth is known by those skilled in the art, such as the Littman® Model 3200 electronic stethoscope, manufactured by 3M Company of Maplewood Minn., which can be suitably modified for use with the present invention.

In another embodiment of the invention, UAV 100 comprises a transponder (not shown) for transmitting ESRI standard or other geo-coded location data of the UAV 100 to third parties, such as FAA flight controllers. In addition, UAV 100 comprises collision avoidance software within flight controller 100 that will automatically redirect UAV 100 if and when it comes close to other flying objects or if its directed flight pattern will ultimately bring it close to other flying objects, such as airplanes, helicopters and other UAVs and/or structures, such as cell towers, tall buildings, mountains, power lines and the like. Navigation information regarding crash avoidance can be directed either to flight controller 110 or external processor 200 for purposes of adjusting the existing configuration (i.e., position and directional movement) of the peer to peer network of UAVs. UAV 100 may further comprise altitude limiting software within flight controller 100 that ensures that UAV 100 does not fly outside a prescribed range of altitudes (e.g., below 400 feet as is currently regulated by the FAA). UAV 100 may also include an application that automatically directs UAV 100 back to base when its power falls below a critical level. This critical level will constantly be updated by software within flight controller 100 and/or external processor 200 as it will depend on the location of UAV 100 relative to its base. This feature ensures that UAV 100 will not run out of power while flying and fall out of the sky. In other embodiments, UAV 100 comprises lockdown software within flight controller 110 that interrupts the directed-dispatch instructions of UAV 100 if it is about to run out of power, and instead, redirects UAV 100 to come to a slow and soft landing in an area that does not include a man-made object, such as a building, street, vehicle or the like.

In yet another embodiment of the invention, a plurality of UAVs 100 are used to monitor and collect data from a plurality of remote sites. Each of the UAVs 100 will, for example, be programmed to fly to certain sites at certain times of the day and collect data therefrom. In addition, external processor 200 will include software that keeps track of the location of all of the UAVs 100 during their programmed flights. In the event that the operator wishes to send a UAV 100 to a particular site on-demand (e.g., if a suspected failure has occurred that must be immediately checked), software within external processor 200 is configured to locate the UAV that is closest to the particular site and redirect that UAV from its programmed flying pattern to move to that particular site. In such instance, the anti-collision software on each of the UAVs prevent collisions that may otherwise occur with sudden changes in flight patterns that were not pre-programmed by the operator or the external processor 200.

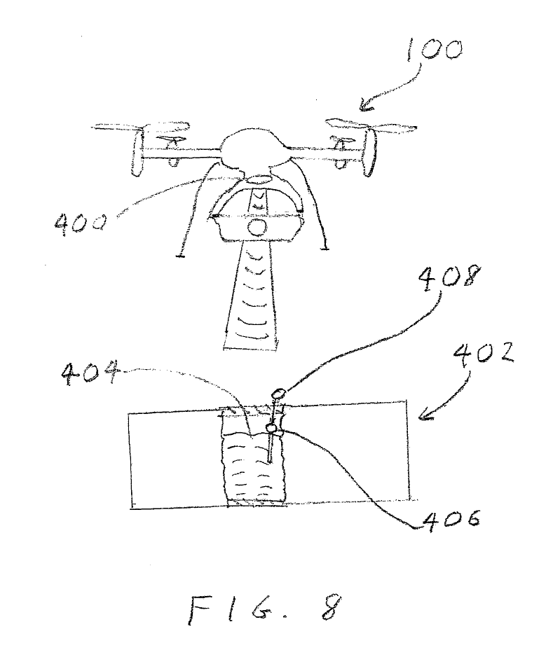

Referring now to FIG. 8, yet another embodiment of the present invention comprises one or more transmitter(s) 400 located on body 102 of UAV 100 and configured to transmit waves to an object containing a fluid for the purposes of measuring the level and/or properties (e.g., oil content) of the fluid within the object. In one embodiment, transmitter 400 comprises a wave transmitter designed to emit microwaves, light waves (e.g., infrared light), laser or the like for measuring fluid levels and/or properties within an object, such as a storage tank 402. In one example of the use of this embodiment, UAV 100 is dispatched to a remote site comprising one or more fluid tanks 402 that contain an unknown quantity or quality of a fluid 404. For example, in certain oil and gas refineries and wells, produced water, such as fracking waste fluid and the like, is generated over time within storage tanks in a non-linear and sometimes unpredictable manner. Produced water and/or fracking fluid in particular must be monitored closely by operators as it represents a potential environmental hazard. Typically, operators are required to physically inspect the storage tanks on a regular basis to ensure that the level of the produced or waste fluid is within safe parameters. With the present invention, UAV 100 may be dispatched to a location near the storage tank(s) such that transmitter 400 is able to determine these levels and transmit this data to flight controller 110. UAV 100 may be further configured to provide instructions to a remote transmitter and/or controller at the refinery to change operating parameters based on the properties or level of the fluid. Alternatively, UAV 100 may relay the data with transmitter 124 to external processor 200 and/or user input 202.

Alternatively, the present invention may comprise a float sensor 408 residing within storage tank 402 and floating on fluid 404. One suitable float sensor that can be used with the present invention is the Gems Alloy Float Level Sensor, manufactured by Gems Sensors and Controls of Plainville, Conn., although those of skill in the art will recognize that other commercially available fluid level sensors may be used in conjunction with the present invention. Float level sensor 406 determines the level of fluid 404 within storage tank 402. In some embodiments, float level sensor 406 comprises a transmitter 408 that allows sensor 406 to transmit data on the fluid levels via Bluetooth, WI FI or the like. The data may be transmitted to controller 208 at the site, where it will then be picked up by UAV 100 during normal data collection procedures, as described above. Alternatively, float level sensor 406 may be directly or indirectly hardwired to RTU 206 or controller 208 for direct transmission of fluid level data. In other embodiments, UAV 100 comprises an antenna or receiver (not shown) for receiving signals or data from float transmitter 408 and may be programmed to fly near float level transmitter 408 for such purpose. In yet other embodiments, float level sensor 406 may have a simple digital or analog display of the float level that is coupled to sensor 406 and mounted outside of the storage tank. In these embodiments, UAV 100 may be programmed to fly near the display and capture an image of the digital or analog data that indicates the level of the fluid. This image may then be stored and transmitted to flight controller 110 for further processing (e.g., decision making) and/or relayed back to external processor 200 for analysis by the operator.

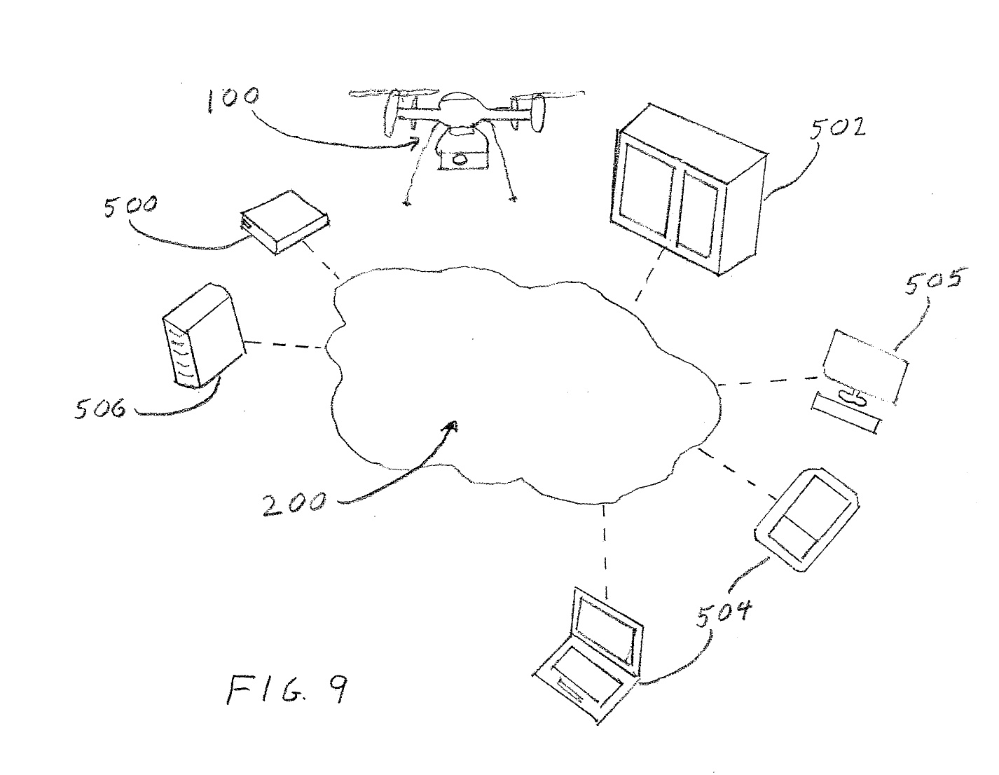

Referring now to FIG. 9, an exemplary method for collecting data from remote sites will now be described. UAV 100 is automatically and routinely dispatched to a plurality of remote oil and/or natural gas sites and refineries by external processor 200, which may comprise one or more server-based systems that utilize automated dispatched service application(s) 500 and GPS and telemetry applications 506. Alternatively, UAV 100 may be dispatched or controlled directly by the user, via a user-directed dispatch application 505 coupled to one or more input devices, 504, such as a mobile phone, computer, tablet or the like, to confirm a nonfunctioning or inadequately functioning well and/or to identify the causes of failure at a remote site (e.g., visual and/or audio confirmation of pump failure). The method typically employs a combination of server-based programs, on-board computer application(s) and UAV(s) 100 to rapidly and cost-effectively move to each of the oil and natural gas sites or refineries, gather significant data 502 from these sites and transmit that data 502 to the external processor so that the operator is immediately aware of the operational status of the site and any potential or actual failures. UAV 100 may perform multi-faceted verification of general operation parts, tank levels or well status at remote well sites, collection of other detailed well data or image capture. This data, video and photos 502 are collected for subsequent upload to central server(s) and/or cloud computing apparatus(es) 200 for eventual transmittal and display to one or more user input devices 504.

Preferably, processor 200 provides dispatch instructions that cause UAV 100 to fly to a particular remote site, collect data from that site, and then fly to another remote site and repeat the process. Once UAV 100 has completed data collection from all of the sites on its route, it will return to base. At a particular site, UAV 100 will fly to designated locations around the site and capture images of those locations to send back to external processor 200. These images enable the operator to view the remote site in almost real-time to determine if the well is operating properly. Historical reporting and trend analysis may also be performed on the collected data for purposes of anticipating part failures, adjusting parts, adjusting inventories and other reporting functions. While UAV 100 is on-site, digital receiver 120 will establish a WI FI connection with remote transmitter 206 and upload all data generated by controller 208 at the site. This data may optionally include airborne particulates in the ambient environment around the well site, toxic gas concentrations, fluid levels and/or properties within storage tanks and/or audio files of sounds emanating from selected equipment at the site. Alternatively, UAV 100 may be directed to fly to selected locations around the remote site to directly gather these data through sensor(s) 300 and/or microphone(s) 304 located on UAV 100 or at selected locations around the remote site (i.e., wirelessly, image capture of data displays or the like).

UAV 100 transmits the collected data from the well site to external processor 200 through any of a variety of signal transmissions (cellular, microwave, radio, etc), preferably in real-time. If there is no signal transmission available at the remote site, UAV 100 stores the data and then transmits when it has moved away from the remote site to an area where such signal is available. Alternatively, UAV 100 may transmit the data to another UAV located nearby which can eventually relay the data back to the external processor or cloud telemetry.

UAV 100 may make decisions based on the data gathered at each of the remote sites. These decisions may be translated into instructions, commands or data that is transmitted to the remote site (e.g., via remote transmitter 206) while UAV 100 is on-site to change operating parameters at the well site. Alternatively, UAV 100 may relay the data to processor 200 and wait for instructions or data from the processor, which may be sent automatically or manually directed by an operator viewing the data on user input 202. The data being transmitted may be 4-20 mA analogue signals or Modbus data originating from a local TCP or RS 232 connection, Modbus data directly from the RTU, PLC (Programmable Logic Controller) or other SCADA-based data transmitted to an RTU or Ethernet or any other type of remote transmitter configuration that is currently, or could be, used at remote sites, such as oil and gas wells, refinery and processing plants, windmill farms, coal mines, pipelines, nuclear reactors, research stations, manufacturing production lines or the like. In general terms, the data may include, but is not limited to, well input data, pump controller data, airborne particulate data, toxic gas concentrations, certain load and other calculated results, tubing and casing pressures, pump and plunger calculations, produced water and other tank level indicators, fluid properties (e.g., oil content), pump stroke, load, capacity, rpm, oil and water gravity readings, temperature and other fluid properties, torque analysis, energy consumption, rpm of meter with magnetic pickup, strokes per minute with magnetic pickup, voltage and amperage from an electrical control box adjoined to a POC, various pressure sensors, including tubing and casing located at the wellhead, chemical and fluid levels to various storage tanks, audio files or sounds emanating from equipment, such as pumps and other routine readings.

In another aspect of the invention, systems and methods are provided for collecting data at oil refinery and processing plants or other remote sites that generate toxic gas or other airborne gases or particulates. In addition to the above tasks, UAV 100 comprises one or more sensor(s) 300 configured to detect toxic gas concentrations or other airborne particulates in the ambient environment. In this embodiment, UAV 100 is dispatched to the site and flown to selected locations around the site that may contain concentrations of toxic gas. Sensor(s) 300 detect the amount of toxic gas at these locations and transfer this data to flight controller 110. Alternatively, sensors 302 may be located at selected locations around the remote site for detecting toxic gas concentrations. In this latter embodiment, sensor(s) 320 may be equipped with a transmitter (e.g., Bluetooth, WI FI or the like) to directly transmit data to UAV 100 or to the remote site's RTU 206 for capture by the data receiver onboard UAV 100. Alternatively, sensors 302 may be directly or indirectly hardwired to RTU 206 via controller 208. In yet another alternative, sensors 302 may comprise a visual display of data that is captured by camera 106 on UAV 100.

In another embodiment of the present invention, systems and methods are provides for collecting data from components or parts of a machine in a manufacturing production line. In this embodiment, a plurality of UAVs 100 each comprise one or more image capture devices designed to quickly capture images of parts on a production line. The UAVs are configured to hover at a selected location on the production line and to capture image of each part as it passes by the UAV. The UAVs further comprise one or more transmitters for transmitting the images to an external processor for analysis and decision making (e.g., whether the part has flaws). Alternatively, the analysis and decision making may be made by a controller or processor on the UAV. The image capture device in this embodiment may be any of the devices previously described or more advanced devices, such as the artificial retina developed by engineers from the Imperial College London (e.g., “the bionic eye”). Such an artificial retina is capable of capturing only those moving elements essential for computer processing, which is then used to produce a video stream that can be transmitted to a display.

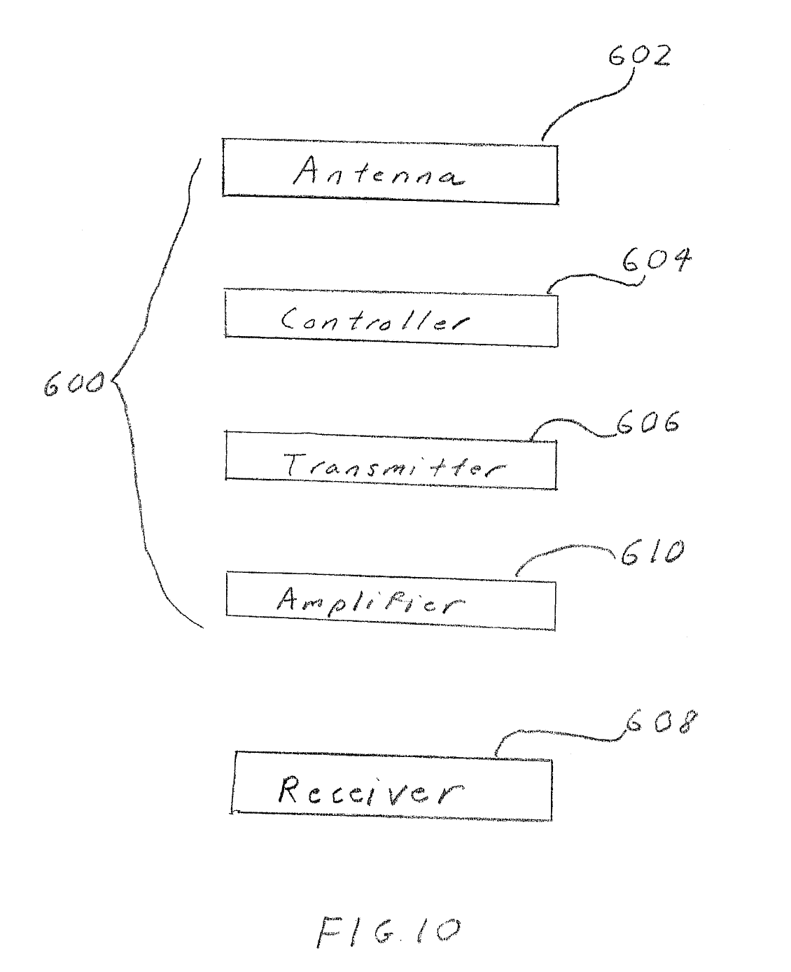

FIG. 10 is a flowchart illustrating yet another alternative embodiment of the current invention. In this embodiment, UAV 600 is used in remote areas where signal coverage is inadequate or completely absent. UAV 600 comprises one or more antennas 602 for receiving cellular, internet, intranet, VPN, television or other signal transmissions and/or data from sources 604, such as mobile phones, computers, televisions or the like. UAV 600 further comprises one or more transmitters 606 for transmitting or relaying these signals or data to an external receiver 608, such as a cell tower, satellite or the like. Thus, UAV 600 acts as a mobile cell tower, WI FI hotspot or satellite dish to relay signal transmissions or data that would otherwise be too weak to reach external receiver 608. In certain embodiments, UAV 600 may comprise a signal amplifier 610 for amplifying the signal transmission to extend the distance in which they may be transmitted from UAV 600 to the external receiver 608.

In certain extremely remote areas, signal amplifier 610 may not be sufficient to transmit all of the data or signal transmissions in a timely fashion to external receiver 608. In such event, the present invention provides a peer-to-peer network comprising a plurality of UAVs 600 configured to relay data or signal transmission to each other until the data or signal transmission can reach the external receiver 608. In this embodiment, each UAV 600 preferably comprises software applications (not shown) enabling UAV 600 to search for external receiver 68 and/or another UAV 600. These software applications will cause UAV 600 to transmit the data or signal transmission to, for example, another UAV 600 or signal repeater positioned in a different location. This transmission from UAV to UAV will continue until one of the UAVs locates external receiver 608. In this manner, the peer-to-peer network can relay data or signal transmission from sources 604 to external receiver 608 in remote areas where signal coverage is limited or completely unavailable.

In another aspect of the invention, a system comprises a plurality of UAVs each having one or more video cameras, such as the one shown in FIG. 2, and a flight controller configured to store still or video images taken by the video camera(s) into data files. The system further comprises a central processor, server(s), cloud(s) or the like capable of assigning IP addresses to each of the UAVs and connected to the internet or world wide web through a standard HTTP or FTD protocol or the like. The UAVs may also each have physical locations (e.g., the corner of 42nd and Broadway) or they may have physical areas in which they patrol or move around (e.g., the border between two countries). The central processor is configured to locate a UAV based on either its IP address or its physical address. In this embodiment, a user having an input device may connect directly to one of the UAVs by searching an IP or physical address through the central server. Thus, the user may be able to download stored or live video files from the flight controller of the UAV onto his/her own user input device, e.g., mobile phone, computer, tablet or the like. Alternatively, the user may be able to view the video taken by the image capture device on the UAV in real-time by dialing up the IP or physical address of a particular UAV and being directed to the flight controller of the UAV.

Although the invention herein has been described with reference to particular embodiments, it is to be understood that these embodiments are merely illustrative of the principles and applications of the present invention. It is therefore understood that modifications may be made to the illustrative embodiments and that other arrangements may be devised without departing from the spirit and scope of the invention as defined by the appended claims.

I claim:

1. A system for collecting data at a remote site comprising:
an unmanned aerial vehicle configured to move to a remote site and to wirelessly receive data associated with the remote site; and
a processor wirelessly coupled to the unmanned aerial vehicle, wherein the unmanned aerial vehicle is configured to wirelessly transmit the data to the processor.

2. The system of claim 1 further comprising a data transmitter located at the remote site, wherein the unmanned aerial vehicle is configured to wirelessly connect to the data transmitter and receive data associated with the remote site from the data transmitter.

3. The system of claim 2 wherein the unmanned aerial vehicle comprises a digital connection receiver having a software application configured to use decision making processes to be performed against the data transmitter.

4. The system of claim 1 wherein the unmanned aerial vehicle comprises an image capture device for capturing images of the remote site.

5. The system of claim 1 wherein the unmanned aerial vehicle comprises a digital storage application for storing the data associated with the remote site.

6. The system of claim 1 further comprising one or more sensors configured to detect airborne particulates or gas concentrations from an ambient environment at the remote site.

7. The system of claim 6 wherein the airborne particulates or gas concentrations are selected from a group comprising hydrogen sulfide, hydrocarbons, ammonia, carbon monoxide, carbon dioxide, arsine, phosphine, hydrogen cyanide, sulfur oxide, oxygen, radioactive particles and methane gas.

8. The system of claim 6 wherein the one or more sensors are located on the unmanned aerial vehicle.

9. The system of claim 6 wherein the one or more sensors are located at the remote site and each comprise a transmitter for wirelessly transmitting data collected by the sensors to the unmanned aerial vehicle.

10. The system of claim 1 further comprising a logic-based application configured to analyze the data collected from the remote site and to make a decision based on the data.

11. The system of claim 10 further comprising a command application configured to wirelessly transmit instructions or data based on a decision of the logic-based application to the remote site to change one or more operating parameters at the remote site.

12. The system of claim 11 wherein the logic-based application and the command application are located on the unmanned aerial vehicle.

13. The system of claim 1 further comprising one or more sound sensors configured to detect sounds emanating from the remote site.

14. The system of claim 13 wherein the sound sensors are located on the unmanned aerial vehicle.

15. The system of claim 13 wherein the sound sensors are located at the remote site and each comprise a transmitter for wirelessly transmitting data collected by the sound sensors to the unmanned aerial vehicle.

16. The system of claim 1 further comprising one or more devices for measuring fluid levels or properties of fluid located at the remote site.

17. The system of claim 16 wherein the devices comprise light wave transmitters located on the unmanned aerial vehicle.

18. The system of claim 16 wherein the devices comprise fluid level sensors located within fluid at the remote site, the fluid level sensors comprising a transmitter for wirelessly transmitting data associated with a fluid level to the unmanned aerial vehicle.

19. The system of claim 1 wherein the unmanned aerial vehicle further comprises a dispatch software program configured to receive dispatch instructions from the processor including GPS information to move to the remote site.

20. A method for collecting data from a remote site comprising:
moving an unmanned aerial vehicle to the remote site;
collecting data from the remote site with the unmanned aerial vehicle; and
wirelessly transmitting said data to a processor located remotely from the remote site.

21. The method of claim 20 wherein the collecting step is carried out by moving the unmanned aerial vehicle to selected locations about the remote site and capturing images of the remote site from the selected locations.

22. The method of claim 20 wherein the collecting step comprises sensing airborne particulates or gas concentrations in an ambient environment about the remote site.

23. The method of claim 22 wherein the sensing step is carried out by moving the unmanned aerial vehicle to a selected location at the remote site and detecting the airborne particulates or gas concentrations with the unmanned aerial vehicle.

24. The method of claim 22 wherein the sensing step is carried out by positioning a gas sensor at a selected location at the remote site and wirelessly transmitting information from the gas sensor to the unmanned aerial vehicle.

25. The method of claim 20 wherein the collecting step comprises recording sounds at a selected location at the remote site.

26. The method of claim 25 wherein the recording step is carried out by moving the unmanned aerial vehicle near the selection location and recording sounds with the unmanned aerial vehicle.

27. The method of claim 25 wherein the recording step is carried out by positioning a sound sensor at the selected location and wirelessly transmitting an audio file of recorded sound from the sound sensor to the unmanned aerial vehicle.

28. The method of claim 20 wherein the collecting step comprises detecting fluid levels or properties at the remote site.

29. The method of claim 28 wherein the detecting step is carried out by transmitting light waves from the unmanned aerial vehicle to fluid at the remote site and receiving reflected light waves at the unmanned aerial vehicle.

30. The method of claim 28 wherein the detecting step is carried out by positioning a fluid level sensor on or within fluid at the remote site and wirelessly transmitting information on the fluid level to the unmanned aerial vehicle.

31. The method of claim 20 further comprising analyzing the data collected at the remote site with the unmanned aerial vehicle and transmitting instructions or data to the remote site to change one or more operating parameters at the remote site based on the data.

32. An unmanned aerial vehicle for collecting data at a remote site comprising:
a software program configured to receive dispatch information from an external processor and to move to the remote site based on the dispatch information;
a means for collecting data from the remote site; and
a transmitter configured to transmit said data to the external processor.

33. The vehicle of claim 32 wherein the data collecting means comprises a connection receiver configured to wirelessly connect to a data transmitter at the remote site to receive data from the remote site.

34. The vehicle of claim 32 wherein the data collecting means comprises a gas sensor configured to detect airborne particulates or gas concentrations at the remote site.

35. The vehicle of claim 32 wherein the data collecting means comprises a software application configured to move the unmanned aerial vehicle to one or more selected locations about the remote site and an image capture device configured to capture images at the selected locations.

36. The vehicle of claim 32 wherein the data collecting means comprises a sound sensor configured to detect sounds emanating from the remote site and a sound recorder configured to record said sounds.

37. The vehicle of claim 32 wherein the data collecting means comprises means for measuring fluid levels or properties at the remote site.

38. The vehicle of claim 32 further comprising a digital storage application for storing the data.

39. The vehicle of claim 32 further comprising a flight controller having a logic based application configured to analyze the data and to make a decision based upon the data and a software application configured to wirelessly transmit data or instructions to the remote site based on the decision made by the logic based application to change one or more operating parameters at the remote site.
